(19) United States
(12) Patent Application Publication
(10) Pub. No.: US 2004/0260015 A1
(43) Pub. Date: Dec. 23, 2004

(54) Aqueous preparations of hydrophilic polyurethane resins

(76) Inventors: Thomas Munzmay, Dormagen (DE); Detlef-Ingo Schutze, Odenthal (DE); Jurgen Meixner, Krefeld (DE); Michael Heckes, Krefeld (DE)

Correspondence Address: BAYER MATERIAL SCIENCE LLC, 100 BAYER ROAD, PITTSBURGH, PA, 15205, US

(21) Appl. No.: 10/869,112

(22) Filed: Jun. 16, 2004

(30) Foreign Application Priority Data
Jun. 23, 2003 (DE) 10328063.4

(51) Int. Cl. C08K 3/00

(52) U.S. Cl. 524/589

(57) ABSTRACT

Aqueous preparations of hydrophilic polyurethanes and their use for the coating of substrates. The polyurethanes contain from 2 to 20 wt. % in relation to solids of terminal or lateral groups of formula (I)

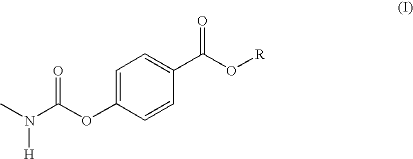

wherein R represents C₁-C₁₈ alkyl or cycloalkyl.

### CROSS REFERENCE TO RELATED PATENT APPLICATION

The present patent application claims the right of priority under 35 U.S.C. §119 (a)-(d) of German Patent Application No.103 28 063.4, filed Jun. 23, 2003.

### FIELD OF THE INVENTION

The present invention relates to aqueous preparations of hydrophilic polyurethanes and their use for the coating of substrates and the finishing of flexible substrates such as for example woven and non-woven textiles, leather, paper.

### BACKGROUND OF THE INVENTION

Aqueous preparations of synthetic polymers have been of the greatest importance in the field of textile and leather finishing for decades. As a result of the combination of favourable properties, such as high elasticity, good low-temperature properties, chemical resistance and pleasant feel that polyurethanes combine, these are preferred, particularly in high-quality products.

A distinction is made in principle between two different types of system, depending on processing method. These are on the one hand the so-called single component system (1K system), which is aqueous preparations of high-molecular polyurethanes, which film over after application by simply drying out. A great advantage of these systems is e.g. that they are easy to handle as there is no need to mix several components together nor is there any reason to fear pot-life problems. The disadvantages of these systems are often the lack of adhesion to the substrate, as the lack of reactive groups means that it is impossible to produce a true chemical bond to the substrate, and their low moisture- and solvent-resistance. Attempts are often made to counteract this by adding reactive components such as e.g. polyisocyanates. Apart from the fact that the main advantages of true 1K systems—simple preparation, no pot-life problems—are thereby lost, this often produces a detrimental change in the polymer properties such as flexibility, low-temperature elasticity etc.

In contrast to this are the true two component systems (2K systems), which consist of the aqueous preparation of a comparably low-molecular, hydroxyl group-containing polyurethane and a polyisocyanate crosslinker. 2K systems produce coatings with excellent solvent resistance and adhesion to various substrates. The disadvantage of these systems is that processing is substantially more costly as a result of the dosing and mixing of various components, and pot-life is limited.

According to the doctrine of DE-A 1 954 8030, when using aqueous preparations of polyurethanes, which have a proportional content of so-called blocked isocyanate groups, and crosslinking these with polyamines, products are obtained that have the favourable properties of the 2K systems such as solvent resistance and adhesion to various substrates, without the problem of limited pot-life, as the blocked isocyanate groups deblock only at increased temperature and then react with the polyamine crosslinkers. However, all blocking agents listed in the named publication have specific disadvantages. On the one hand blocking agents are described, that cannot be used in all processes as a result of their high activation temperature. On the other, blocking agents with a very low dissociation temperature are named, such as e.g. malonic acid dialkyl esters, which, as a result of their high reactivity, have only limited storage stability in water. The optimum blocking agents with regard to storage stability in aqueous preparations and reactivity, butanone oxim and diisopropyl amine, are classified as hazardous substances and thus require increased expenditure for occupational health and safety, which inevitably leads to higher costs for the end user of these products.

There was thus an urgent need for products that do not have the above-mentioned disadvantages and problems of the known systems.

### SUMMARY OF THE INVENTION

The present invention is directed to aqueous preparations of polyurethanes containing from 2 to 20 wt. % in relation to solids of terminal or lateral groups of formula (I)

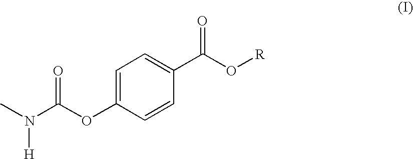

where R represents C₁-C₁₈ alkyl or cycloalkyl.

The present invention is also directed to a process for preparing the above-described preparations including reacting in a first stage, the synthesis components i), ii), iii), iv), vA) or vC), and vii) as indicated below:

i) organic compounds containing at least two free hydroxyl groups, which are capable of reacting with isocyanate groups,

ii) diols and polyols of the molecular weight range 62 to 299,

iii) synthesis components for the incorporation of terminal and/or lateral ethylene oxide units according to of formula (III)

H—Y′—X—Y—R (III)

where

R represents a monovalent hydrocarbon group with 1 to 12 carbon atoms,

X represents a polyalkylene oxide chain with 5 to 90 ethylene oxide units and optionally propylene oxide, butylene oxide or styrene oxide units, and

Y and Y¹ independently represent oxygen or —NR′—, wherein R′ represents H or C₁-C₁₈ alkyl or cycloalkyl,

iv) organic compounds having at least two free isocyanate groups per molecule, and

optionally

v) synthesis components which are at least monofunctional according to the isocyanate polyaddition reaction and additionally contain at least one anionic or one potentially anionic group selected from vA) mono and dihydroxy-carboxylic acids or their salts and vC) sulfonate group-containing aliphatic diols, and

vii) p-hydroxybenzoic acid esters of formula (II)

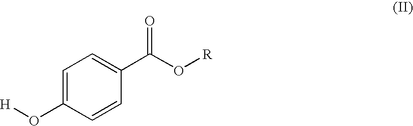

where R represents C₁ to C₁₈ alkyl or cyclo-alkyl,

to form a prepolymer, the required quantities of the individual synthesis components being measured in such as way as to result in an isocyanate index of 1.05 to 4.5, then in a second stage, dissolving the prepolymer in an organic solvent and optionally in a third stage reacting the isocyanate-containing prepolymer solution with

vB) mono- and/or diamino carboxylic acids or their salts and/or mono- and/or diamino sulfonic acids or their salts, and/or

vi) aliphatic and/or alicyclic primary and/or secondary polyamines

optionally neutralizing potentially anionic components before or after the third stage and either the components vA) or vC) being used in the first stage and/or component vB) being used in the third stage, precipitating the dispersion in a fourth stage by the addition of water, and removing the organic solvent in a final stage.

The present invention is further directed to a method of coating or producing substrates including applying the above described preparations to a surface of the substrates. In an embodiment of this method, substrates are coated by optionally pre-coating the substrates with a coagulating agent, optionally heating the substrate, coating the substrate with or immersing the substrate in the above-described aqueous preparation, and heating the substrate to a temperature at which the p-hydroxybenzoic acid ester dissociates and the isocyanate groups thereby released react with the crosslinker forming a crosslinked polyurethane.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

It was found, that aqueous preparations of polyurethanes containing 2 to 20 wt. % in relation to the solids of terminal and lateral groups of formula (I)

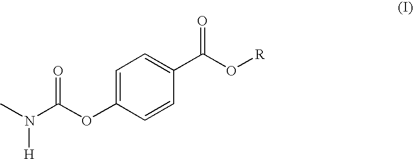

where R═C₁ to C₁₋₈ alkyl or cyclo-alkyl, preferably R═C₂ to C₈ alkyl or cyclo-alkyl, do not have the disadvantages described above of the systems of this type known hitherto.

The aqueous preparations according to the invention preferably contain

a) 29.5 to 60 wt. % of the polyurethanes described previously and

b) 0.5 to 15 wt. % of a polyamine component for the crosslinking of the isocyanate groups formed after specific release or dissociation of the blocking group, and also

c) 70 to 25 wt. % water.

The groups named under I can be obtained by reacting isocyanate-functional products with p-hydroxybenzoic acid esters. The use of p-hydroxybenzoic acid esters to produce blocked isocyanates is known per se e.g. from DE-A 2 514 816 or U.S. Pat. No. 3,313,463. On the other hand, these specifications give no indication that p-hydroxy-benzoic acid esters could be suitable for the production of blocked, storage-stable aqueous dispersions, since, as already described above for malonic acid esters, the storage stability of the blocked isocyanates in water is the critical point for the usability of a blocking agent in an aqueous system. From the publication of T. Regulski & M. R. Thomas, Org. Coat. Appl. Polym. Sci. Proc. 48 (1983) 1003, it can be seen that isocyanates blocked with p-hydroxybenzoic acid esters are characterised by particularly high reactivity. The person skilled in the art would thus have expected that aqueous dispersions that contain p-hydroxybenzoic acid ester-blocked isocyanates have inadequate storage stability.

However, it was found, surprisingly, that aqueous preparations of p-hydroxybenzoic acid ester-blocked isocyanates are not only characterised by their good reactivity to aminic crosslinkers, but also have excellent storage stability even at 50° C.

The use of isophorone diisocyanate blocked with 4-hydroxybenzoic acid esters for powder coatings is disclosed in JP-A 550 03 415, as is the use of 4-hydroxy-benzoate (JP-A 04 144 787) as a blocking agent for polyisocyanates for the production of heat-activated recording materials.

These citations also do not suggest the use of p-hydroxybenzoic acid ester blocked polyisocyanates in aqueous coating systems.

In the context of the invention, the term “polyurethane” also comprises “polyurethane polyureas” i.e. high-molecular compounds, which contain urea groups as well as urethane groups.

Synthesis components i) suitable for the aqueous preparations of polyurethanes are organic compounds, which contain at least two free hydroxyl groups that are capable of reacting with isocyanate groups. Examples of such compounds are higher-molecular compounds of the classes of polyester-, polyester amide-, polycarbonate-, polyacetal- and polyether polyols with molecular weights of at least 300, preferably 500 to 8000, particularly preferably 800 to 5000. Preferred compounds are for example those that contain at least two hydroxyl groups, such as polyether polyols, polyester polyols or polycarbonate polyols.

Linear polyester diols in particular, and also slightly-branched polyester polyols can be considered as polyester polyols, such as those that can be produced in the known way from aliphatic, cycloaliphatic or aromatic di- or polycarboxylic acids or their anhydrides, such as e.g. succinic-, glutaric-, adipic-, pimelic-, suberic-, azelaic-, sebacic-, nonane dicarboxylic-, decane dicarboxylic-, terephthalic-, isophthalic-, o-phthalic-, tetrahydrophthalic-, hexahydrophthalic- or trimellitic acid and also acid anhydrides, such as o-phthalic-, trimellitic- or succinic acid anhydride, or mixtures thereof with polyvalent alcohols such as e.g. ethane diol, di-, tri-, tetraethylene glycol, 1,2-propane diol, di-, tri-, tetrapropylene glycol, 1,3-propane diol, butane diol-1,4, butane diol-1,3, butane diol-2,3, pentane diol-1,5, hexane diol-1,6, 2,2-dimethyl-1,3-propane diol, 1,4-dihydroxy cyclohexane, 1,4-dimethylol cyclohexane, octane diol-1,8, decane diol-1,10, dodecane diol-1,12, or mixtures thereof, optionally with the additional use of higher functional polyols, such as trimethylol propane or glycerine. Cycloaliphatic and/or aromatic di- and polyhydroxyl compounds can of course also be considered as polyvalent alcohols for the production of the polyester polyols. Instead of the free polycarboxylic acid, the corresponding polycarboxylic acid anhydrides or corresponding polycarboxylic acid esters of low alcohols or mixtures thereof can also be used for the production of the polyesters.

Of course, the polyester polyols can also be homo- or mixed polymers of lactones, which are preferably obtained by addition of lactones or lactone mixtures, such as butyrolactone, ε-caprolactone and/or methyl β-caprolactone to suitable di- and/or higher functional starter molecules such as e.g. the low-molecular polyvalent alcohols mentioned previously as synthesis components for polyester polyols.

Polycarbonates having hydroxyl groups can also be considered as polyhydroxyl components, e.g. those that can be produced by reacting diols such as 1,4-butane diol and/or 1,6-hexane diol with diarylcarbonates, e.g. diphenyl carbonate, dialkyl carbonate, such as dimethyl carbonate or phosgene, preferably with a molecular weight of 800 to 5 000.

Suitable polyether polyols are e.g. the polyaddition products of styrene oxide, ethylene oxide, propylene oxide, tetrahydrofuran, butylene oxide and also their mixed addition and graft products, as well as the polyether polyols obtained by condensation of polyvalent alcohols or mixtures of these and by alkoxylation of polyvalent alcohols, amines and aminoalcohols.

Particularly preferred synthesis components are the homo- mixed- and graft-polymers of propylene oxide and ethylene oxide, which can be obtained by the addition of the stated epoxides to low-molecular di- or triols, such as those mentioned above as synthesis components for polyester polyols, or to water.

Further particularly preferred synthesis components are polyester diols based on adipic acid and glycols such as 1,4-butane diol, 1,6-hexane diol and/or 2,2-dimethyl-1,3-propane diol (neopentyl glycol). Mixed polymers of 1,6-hexane diol with (-caprolactan and diphenyl carbonate with a molecular weight of 1 000 to 4 000, as well as 1,6-hexane diol-polycarbonate diols with a molecular weight of 1 000 to 3 000 are also particularly preferred.

Synthesis components ii) that may optionally also be used are di- and polyols of the molecular weight range 62 to 299. The polyvalent, in particular divalent, alcohols and also low-molecular polyester diols such as e.g. adipic acid-bis-(hydroxyethyl)-ester or short-chain homo- and mixed addition products of ethylene oxide or propylene oxide started on aromatic diols mentioned for the production of the polyester polyols, may also be considered for example as these. Preferred synthesis components optionally to be additionally used are 1,2-ethane diol, 1,4-butane diol, 1,6-hexane diol and 2,2-dimethyl propane diol-1,3. 1,4-butane diol and 1,6-hexane diol are particularly preferred.

Other suitable synthesis components ii) are triols such as glycerine, trimethylol propane, trimethylol ethane and/or their alkoxylation products.

The aqueous preparations according to the invention have, in relation to the solid, a content of 0.1 to 20, preferably of 0.5 to 12, particularly preferably of 1.8 to 8 wt. % of terminally and/or laterally incorporated ethylene oxide units as hydrophilic, non-ionic centres, which may be incorporated simply by the additional use of suitable synthesis components iii) in the isocyanate polyaddition process.

Hydrophilic synthesis components iii) for the incorporation of chains having terminal hydrophilic ethylene oxide units are compounds of formula (III)

H—Y′—X—Y—R (III)

in which

R stands for a monovalent hydrocarbon group with 1 to 12 carbon atoms, preferably an unsubstituted alkyl group with 1 to 4 carbon atoms,

X stands for a polyalkylene oxide chain with 5 to 90, preferably 20 to 70 chain links, which consists of at least 40%, preferably of at least 65%, of ethylene oxide units and which, in addition to ethylene oxide units, may consist of propylene oxide, butylene oxide or styrene oxide units, propylene oxide being preferred of the latter units and

Y and Y¹ independently and preferably stand for oxygen or also for —NR′—, wherein the defenition of R′ corresponds to R or hydrogen.

However, monofunctional polyethers are preferably used only in molar quantities of less than 10 mol % in relation to the polyisocyanate used, in order to guarantee the desired high-molecular structure of the polyurethane elastomers. When using larger molar quantities of monofunctional alkylene oxide polyethers, the additional use of trifunctional compounds having hydrogen atoms reactive to isocyanate is advantageous, however provided that the average of the functionality of the starting compounds is not greater than 3. The monofunctional hydrophilic synthesis components are produced in the same way as the compounds obtained according to DE-A 2 314 512 or DE-A 2 314 513 or U.S. Pat. No. 3,905,929 or U.S. Pat. No. 3,920,598 by alkoxylation of a monofunctional starter such as e.g. n-butanol or N-methyl butyl amine using ethylene oxide and optionally a further alkylene oxide such as e.g. propylene oxide.

The mixed polymers of ethylene oxide with propylene oxide with an ethylene oxide mass content greater than 50 mol %, particularly preferably of 55 to 89 mol % are preferred.

In a preferred embodiment, compounds with a molecular weight of at least 400 Dalton, preferably of at least 500 Dalton and particularly preferably of 1200 to 4500 Dalton are used as hydrophilic, non-ionic synthesis components.

Any organic compounds having at least two free isocyanate groups per molecule, such as e.g. diisocyanate X(NCO)₂, wherein X stands for a divalent aliphatic hydrocarbon group having 4 to 12 carbon atoms, a divalent cycloaliphatic hydrocarbon group having 6 to 15 carbon atoms, a divalent aromatic hydrocarbon group having 6 to 15 hydrocarbon atoms or a divalent araliphatic hydrocarbon group having 7 to 15 hydrocarbon atoms are suitable as synthesis components iv). Other examples of compounds that can be used as the diisocyanate component are disclosed e.g. by W. Siefken in Justus Liebigs Annalen der Chemie, 562, p. 75-136.

Examples of diisocyanates preferably used are tetramethylene diisocyanate, methyl pentamethylene diisocyanate, hexamethylene diisocyanate, dodeca-methylene diisocyanate, 1,4-diisocyanato-cyclohexane, 1-isocyanato-3,3,5-trimethyl-5-isocyanato methyl-cyclohexane, 4,4′-diisocyanato-dicyclohexyl-methane, 4,4′-diisocyanato-dicyclohexyl propane-(2,2), 1,4-diisocyanato benzene, 2,4-diisocyanato toluene and 2,6-diisocyanato toluene as well as mixtures of the latter two, 4,4′-diisocyanato-diphenyl methane, 2,2′- and 2,4′-diisocyanato diphenyl methane, p-xylylene diisocyanate, 1,3- and 1,4-diisocyanatomethyl-benzene, and also mixtures consisting of these compounds. 1-isocyanato-3,3,5-trimethyl-5-iso-cyanato methyl-cyclohexane and 4,4′-diisocyanato-dicyclohexyl methane are particularly preferred.

It is of course also possible to use (additionally) proportional quantities of the higher-functional polyisocyanates known per se in polyurethane chemistry and also of modified polyisocyanates known per se containing for example carbodiimide groups, allophanate groups, isocyanurate groups, urethane groups and/or biuret groups.

The polyurethane resin dispersions according to the invention can, in relation to the solid, contain 3 to 30, preferably 7 to 17 mmol anionic groups/100 g polyurethane resin. These ionic groups are incorporated in the known way by the additional use of synthesis components v), which according to the isocyanate polyaddition reaction are at least monofunctional, preferably difunctional and contain additionally at least one anionic or potentially anionic group. Examples of suitable synthesis components are

A) mono- and dihydroxycarboxylic acids or their salts such as for example hydroxypivalic acid, hydroxyvaleric acid, dimethylol propionic acid, dimethylol butyric acid, mono- and dihydroxy sulfonic acids or their salts or

B) mono- and diamino carboxylic acids and their salts such as for example simple natural amino acids such as glycine, alanine and others and also diaminocarboxylic acids obtainable by the addition of acrylic acid to primary aliphatic amines such as ethylene diamine, or their salts, as well as mono- and diamino sulfonic acids or their salts such as for example taurine or the alkali salts of N-(2-aminoethyl)-2-aminoethane sulfonic acid.

Other suitable anionic synthesis components are

C) sulfonate group-containing aliphatic diols, e.g. according to DE-A 2 446 440.

Where the free acids of the potentially anionic compounds are used in the isocyanate polyaddition process, they must be neutralised at any point in time before the conversion of the polyurethanes into the aqueous preparation, by adding amines, preferably tertiary or ternary amines, metal-preferably akali hydroxides, hydrogen carbonates or carbonates. Examples of preferred tertiary amines are triethyl amine, triisopropyl amine, ethyl diisopropyl amine, triethanol amine, triisopropanol amine, methyl diethanol amine, dimethyl ethanol amine etc.

Aliphatic and/or alicyclic primary and/or secondary polyamines can be considered as aminic synthesis components vi), 1,2-ethane diamine, 1,6-hexamethylene diamine, 1-amino-3,3,5-trimethyl-5-aminomethyl-cyclohexane (isophorone diamine), piperazine, 1,4-diaminocyclohexane, bis-(4-aminocyclohexyl)-methane, adipic acid dihyrazide or diethylene triamine as well as hydrazine or hydrazine hydrate e.g. being preferred.

Further suitable polyamines comprise polyether polyamines, which are formally produced by replacing the hydroxyl groups of the polyether polyols described above by amino groups. Such polyether polyamines can be produced by reacting the corresponding polyether polyols with ammonia and/or primary amines.

Other suitable aminic synthesis components are those that bear further reactive groups, preferably alcoholic hydroxyl groups, such as for example ethanol amine, diethanol amine, N-methyl-ethanol amine, 2-propanol amine etc.

1-amino-3,3,5-trimethyl-5-aminomethyl-cyclohexane (isophorone diamine), 1,2-ethane diamine, piperazine, diethylene triamine and hydrazine are particularly preferred as aminic synthesis components.

The incorporation of the groupings (I) according to the invention

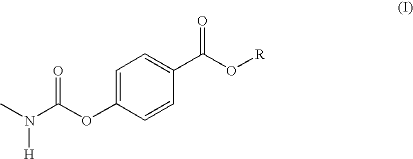

where R═C₁ to C₁₈ alkyl or cyclo-alkyl

can take place at any point in time during the isocyanate polyaddition process by reacting isocyanate groups with p-hydroxy benzoic acid esters of formula (II)

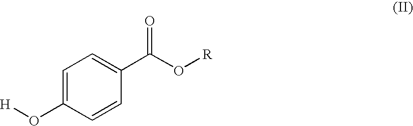

in which R═C₁ to C₁₈ alkyl or cyclo-alkyl, preferably C₂ to C₈ alkyl or cyclo-alkyl. Ethyl-, n-propyl-, i-propyl, n-butyl-, i-butyl- and t-butylesters of p-hydroxybenzoic acid are particularly preferred.

The polyurethane resin dispersions according to the invention are produced by known processes of the prior art, such as described e.g. by D. Dietrich in Houben-Weyl: Methoden der Organischen Chemie, Volume E20, p. 1670-81 (1987). The polyurethane dispersions according to the invention are preferably produced by the so-called acetone process.

In the acetone process, the aqueous preparations of polyurethane resins that form the basis of the dispersions according to the invention are synthesised in a multi-stage process.

The present invention also provides a process for the production of the polyurethane resin dispersions according to the invention, characterised in that

1) in a first step components i) to iv) and optionally v) A) or C) and vii) are reacted to form a prepolymer, then

2) in a second step, the prepolymer is dissolved in an organic solvent and

3) optionally in a third step, the isocyanate-containing prepolymer solution is reacted with the components v) B) and vi),

4) in a following step the dispersion is precipitated out by the addition of water and

5) in a final step the organic solvent is removed.

Potentially anionic components are optionally neutralised before or after step 3).

In a first stage, an isocyanate group-containing prepolymer is synthesised from the synthesis components i) to iv). The required quantities of the individual components are measured in such as way as to result in an isocyanate index of 1.05 to 4.5, preferably of 1.2 to 3. The isocyanate content of the prepolymers is 0.5 to 9.5 wt. %, preferably 1.25 to 7.5 wt. % and particularly preferably 2.5 to 5.5 wt. %.

Where anionic or potentially anionic groups are incorporated into the hydrophilic polyurethane resins according to the invention through synthesis components of the classes described under v), A and C), it is recommended that these be incorporated also at this stage as co-reactants in the prepolymerisation reaction.

The groupings (I) according to the invention are advantageously incorporated at the same time as the synthesis of the isocyanate prepolymer by co-reaction of synthesis component vii) with synthesis components i) to iv) or following prepolymerisation. In this case, when measuring the synthesis components i) to iv), v) A) or C) and vii), care must be taken to ensure that the arithmetical, number average functionality is 1.50 to 3.50, preferably 1.75 to 2.50, particularly preferably 1.90 to 2.25. However, groups (I) according to the invention can also be incorporated at any other time during the synthesis of the polyurethane resins according to the invention.

To accelerate the prepolymerisation reaction and to incorporate the groupings (I) according to the invention, conventional catalysts such as metallorganic catalysts or aminic catalysts can be used. Diazobicyclooctane (DABCO), preferably in quantities of 0.01 to 2, particularly preferably of 0.1 to 1 wt. % in relation to the prepolymer are preferably used.

In a second stage, the prepolymer produced in stage 1 is dissolved in an organic, at least partially water-miscible, solvent, which bears no isocyanate-reactive groups. The preferred solvent is acetone. However, other solvents may also be used, such as for example 2-butanone, tetrahydrofuran or dioxane or mixtures of these solvents. The quantities of solvents to be used are to be measured in such a way as to result in a solid content of 20 to 80 wt. %, preferably of 30 to 50 wt. %, particularly preferably of 35 to 45 wt. %.

In a third stage, the isocyanate-containing prepolymer solution is optionally reacted with mixtures of the amino-functional synthesis components v) B) and vi) lengthening the chain to the high-molecular polyurethane resin. The quantities of synthesis components are measured in such a way that per mol isocyanate groups of the dissolved prepolymers 0.3 to 0.98 mol, preferably 0.5 to 0.85 mol primary and/or secondary amino groups of the synthesis components v) B and vi) result. The arithmetical, number average isocyanate functionality of the resulting polyurethane resin according to the invention is 1.55 to 3.10, preferably 1.90 to 2.35. The arithmetical number average molecular weight (Mn) is 3000 to 250000, preferably 3500 to 40000 Dalton.

In the process according to the invention either the components v)A) or v)C) are used in the first step and/or the component v)B) is used in the third step.

Potentially anionic synthesis components in the form of free acid groups are converted into the corresponding acid anions before, or preferably following, the third stage described above, by the addition of neutralising agents.

In a step following this, the high-molecular polyurethane resin is precipitated out by the addition of water in the form of a fine-particle dispersion.

In a final step, the organic solvent is optionally wholly or partially distilled off under reduced pressure. The quantity of water is measured in the penultimate stage in such a way that the aqueous polyurethane resin dispersions according to the invention have a solid content of 30 to 65, preferably of 35 to 55 wt. %.

The required quantities of the synthesis component are measured in such a way as to result in a content of groups of formula (I) according to the invention of 1 to 35, preferably 2 to 20, particularly preferably 3.5 to 15 wt. % in relation to polyurethane resin.

The present invention further provides the crosslinking of the aqueous preparations of the polyurethane resins according to the invention with suitable crosslinkers at increased temperatures. Suitable crosslinkers are, for example, low-molecular di- and polyols as disclosed under ii) or polyamines, preferably those disclosed under synthesis component vi). The resulting mixtures are crosslinked after applying the mixtures to any substrates by any process such as doctor blade, spreading, spraying, atomising, immersion etc. at temperatures of 80 to 200, preferably 100 to 180 and particularly preferably 130 to 160° C. Here, the quantities of crosslinker components are measured in such as way as to result in a molar ratio of groups (I) according to the invention to reactive groups of the respective crosslinker of 3 to 0.5, preferably 2 to 0.75 and particularly preferably of 1.5 to 0.8.

The aqueous preparations according to the invention can contain auxiliary substances and additives such as for example those conventionally used in leather and textile coating technology, such as pigments, levelling agents, stabilisers, thickeners, fillers etc.

The aqueous preparations according to the invention can be stored almost indefinitely at room temperature. Depending on the crosslinker added, products are obtained which cure at relatively low temperatures of 130 to 160° C. within 1.5 to 3 minutes to form coatings with outstanding wet- and dry adhesion to conventional textiles. The coatings thus obtained and the substrates coated with them are also provided by this invention. The aqueous preparations according to the invention are particularly suitable for the production of coagulates, for example for the production of synthetic leather base materials by coagulation of the aqueous preparations according to the invention in non-woven materials, knit fabrics and other flat textiles or for the production of so-called unsupported flat textiles such as for example gloves or condoms by the coagulation process.

### EXAMPLES

| | |
|---|---|
| Desmophen ® 2020: | Hexane diol polycarbonate diol of |
| | OH—Z = 56; Bayer AG, Leverkusen |
| Baygal ® 70RE30: | Polypropylene oxide triol of OH—Z = 56; |
| | Bayer AG, Leverkusen |
| Desmophen ® 550U: | Polypropylene oxide triol of OH—Z = 385; |
| | Bayer AG, Leverkusen |
| Desmodur ® I: | 1-isocyanato-3,3,5-trimethyl-5- |
| | isocyanatomethyl-cyclohexane (isophorone |
| | diisocyanate): Bayer AG, Leverkusen |
| Desmodur ® 44M: | 4,4′-methylene-diphenyl diisocyanate; |
| | Bayer AG, Leverkusen |
| Impranil ® ELH: | Solution of an aliphatic polyurethane; |
| | Bayer AG, Leverkusen |
| Imprafix ® VP LS 2330: | Akyl amine; |
| | Bayer AG, Leverkusen |
| DABCO: | Diazabicyclooctane; |
| | Supplier Aldrich Chemie, Steinheim |
| Walocel ® MT 6000PV: | Cellulose-based thickener, |
| | Supplier Wolff Cellulosics GmbH & Co. KG, |
| | Walsrode |

### Example 1

2000 g Desmophen® 2020, 1200 g Baygal® 70RE30 and 300 g of a monofunctional, ethylene oxide-rich polyether (78 wt. % ethylene oxide) with an OH number of 26 are dehydrated for 1 hour at 120° C. and 15 mbar. 245 g p-hydroxybenzoic acid methyl ester and 5 g DABCO are then added at 100° C. As soon as the mixture is homogeneously combined, 744 g Desmodur® I is added. The mixture is stirred at 90 to 100° C. until a constant isocyanate content of 1.6 to 1.40% is achieved. The reaction product is diluted with 4000 g acetone and cooled to 40° C.

Within 5 minutes 650 g of a 30% solution of an adduct of 1 mol acrylic acid and 1 mol 1-amino-3,3,5-trimethyl-5-aminomethyl-cyclohexane (isophorone diamine) and then 71 g triethyl amine in 400 g water are added. 15 minutes after complete addition of the amine solutions 3850 g de-ionised water is added whilst stirring vigorously. The acetone is distilled off at 40 to 50° C. bottom temperature and reduced pressure.

A fine-particle dispersion with a solid content of 50.1 wt. %, pH=8.1 and a flow time (to DIN 53 211, 4 mm nozzle) of 38 seconds is obtained.

### Example 2

2000 g Desmophen® 2020, 1200 g Baygal® 70RE30 and 300 g of a monofunctional, ethylene-oxide rich polyether (78 wt. % ethylene oxide) with an OH number of 26 are dehydrated for 1 hour at 120° C. and 15 mbar. 265 g p-hydroxybenzoic acid ethyl ester and 5 g DABCO are then added at 100° C. As soon as the mixture is homogeneously combined, 744 g Desmodur® I is added. The mixture is stirred at 90 to 100° C. until a constant isocyanate content of 1.6 to 1.40% is achieved. The reaction product is diluted with 4000 g acetone and cooled to 40° C.

Within 5 minutes 650 g of a 30% solution of an adduct of 1 mol acrylic acid and 1 mol 1-amino-3,3,5-trimethyl-5-aminomethyl-cyclohexane (isophorone diamine) and then 71 g triethyl amine in 400 g water are added. 15 minutes after complete addition of the amine solutions 3850 g de-ionised water is added whilst stirring vigorously. The acetone is distilled off at 40 to 50° C. bottom temperature and reduced pressure.

A fine-particle dispersion with a solid content of 50.5 wt. %, pH=7.7 and a flow time (to DIN 53 211, 4 mm nozzle) of 85 seconds is obtained.

### Example 3

2000 g Desmophen® 2020, 1200 g Baygal® 70RE30 and 300 g of a mono-functional, ethylene oxide-rich polyether (78 wt. % ethylene oxide) with an OH number of 26 are dehydrated for 1 hour at 120° C. and 15 mbar. 290 g p-hydroxybenzoic acid-1-propylester and 5 g DABCO are then added at 100° C. As soon as the mixture is homogeneously combined, 744 g Desmodur® I is added. The mixture is stirred at 90 to 100° C. until a constant isocyanate content of 1.6 to 1.30% is achieved. The reaction product is diluted with 4000 g acetone and cooled to 40° C.

Within 5 minutes 650 g of a 30% solution of an adduct of 1 mol acrylic acid and 1 mol 1-amino-3,3,5-trimethyl-5-aminomethyl-cyclohexane (isophorone diamine) and then 71 g triethyl amine in 400 g water are added. 15 minutes after complete addition of the amine solutions 3900 g de-ionised water is added whilst stirring vigorously. The acetone is distilled off at 40 to 50° C. bottom temperature and reduced pressure.

A fine-particle dispersion with a solid content of 50.2 wt. %, pH=8.0 and a flow time (to DIN 53 211, 4 mm nozzle) of 53 seconds is obtained.

### Example 4

2000 g Desmophen® 2020, 1200 g Baygal® 70RE30 and 300 g of a monofunctional, ethylene oxide-rich polyether (78 wt. % ethylene oxide) with an OH number of 26 are dehydrated for 1 hour at 120° C. and 15 mbar. 265 g p-hydroxybenzoic acid ethyl ester and 5 g DABCO are then added at 100° C. As soon as the mixture is homogeneously combined, it is cooled to 70° C. and 838 g Desmodur® 44M is added. The mixture is stirred at 60 to 70° C. until a constant isocyanate content of 1.5 to 1.20 wt. % is achieved. The reaction product is diluted with 4000 g acetone and cooled to 40° C. 600 g of a 30% solution of an adduct of 1 mol acrylic acid and 1 mol 1-amino-3,3,5-trimethyl-5-aminomethyl-cyclohexane (isophorone di amine) and then 65 g triethyl amine in 400 g water are added within 5 minutes. 15 minutes after complete addition of the amine solutions 4000 g de-ionised water is added whilst stirring vigorously. The acetone is distilled off at 40 to 50° C. bottom temperature and reduced pressure.

A fine-particle dispersion with a solid content of 49.3 wt. %, pH=7.5 and a flow time (to DIN 53 211, 4 mm nozzle) of 33 seconds is obtained.

### Example 5

Samples of the polyurethane resin dispersion according to examples 1 to 4 were stored at 50° C. in an air-circulating drying cabinet and the stability of each dispersion was inspected visually every week.

Storage stability at 50° C.

| Ex- | 1^{st} | 2^{nd} | 3^{rd} | 4^{th} | 5^{th} | 6^{th} |
|---|---|---|---|---|---|---|
| ample | Week | Week | Week | Week | Week | Week |
| 1 | stable | stable | stable | sedimented | | |
| 2 | stable | stable | stable | stable | stable | stable |
| 3 | stable | stable | stable | stable | stable | stable |
| 4 | stable | stable | stable | stable | stable | stable |

### Example 6

### Reinforcement of Non-Woven Material

Liquor Composition:

| Component/parts | Example 6A | Example 6B |
|---|---|---|
| Example 1 | 100 | 100 |
| Isophorone diamine | — | 2.5 |
| Water | 400 | 400 |

An un-pretreated, un-sized non-woven material based on polyamide and polyester fibres is immersed in a liquor according to the above table, padded and treated in a 95° C. water bath in broad state, thus coagulating the polyurethane resin. The non-woven material is then squeezed out, dried at 120° C. and condensed at 150 to 160° C. within 2 minutes. The initial gel solidifies to form a dry, resistant film. By means of further mechanical treatment, such as tumbling, buffing, napping or by means of additives such as finishing agents, a large number of feel variants can be achieved. By splitting the non-woven material in a similar way to leather production, the thickness of the non-woven material can easily be controlled.

### Example 7

### Unsupported Gloves

| Component/parts | Example 7A | Example 7B |
|---|---|---|
| Example 1 | 100 | 100 |
| Isophorone diamine | — | 2.0 |
| Water | 100 | 100 |

A ceramic mould heated to 90 to 120° C. is first immersed in an aqueous liquor containing 6 wt. % Ca(NO₃)₂, 3 wt. % of a commercial emulsifier (Emulsifier WNS, Bayer AG, Leverkusen) and 10 wt. % of finely ground CaCO₃. The mould is then dried for 2 minutes at 90 to 120° C. and immersed in one of the liquors described in the above table. Depending on the desired film thickness, the residence time is 5 to 30 seconds. The coated mould is then immersed for 30 seconds in a water bath heated to 90° C. and then condensed for 3 minutes at 160° C. A soft, elastic, pore-free alcohol-resistant film is obtained.

### Example 8

### Adhesive Coating

100 g of a dispersion according to example 2 is intensively mixed with 2.5 g Imprafix® VP LS 2330. By adding 0.3 g Walocel® MT 6000PV the mixture is thickened to a spreadable viscosity.

A solvent-containing top coating (Impranil® ELH) and then the above adhesive coating mixture (dry application ca 15 g/m²) are applied with a doctor blade to interleaving paper and pre-dried at 100° C. The substrate, a polyurethane coagulate-coated textile is then laid over at room temperature and pressed on. The whole coating structure cures without pressure at 160° C. (substrate temperature) in 2 minutes. Coagulate synthetic leathers coated in this way pass the Bally flexometer test without damage (150,000 bends dry, 100,000 bends wet) and have excellent dry- and wet adhesion to the substrate.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Aqueous preparations of polyurethanes containing from 2 to 20 wt. % in relation to solids of terminal or lateral groups of formula (I) 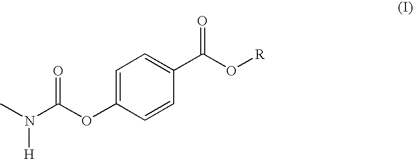
wherein R represents C₁-C₁₈ alkyl or cycloalkyl.

2. The preparations according to claim 1, wherein R in formula (I) represents C₂- to C₈-alkyl or cycloalkyl.

3. The preparations according to claim 1, wherein the polyurethanes comprise hydrophilic, ionic or ionomeric groups.

4. The preparations according to claim 3, wherein the aqueous preparations comprise 29.5 to 60 wt. % of the polyurethanes, 0.5 to 15 wt. % of a polyamine component and 70 to 25 wt. % water, based on the weight of the preparations.

5. A process for the production of the preparations according to claim 1, comprising
reacting in a first stage, the synthesis components
i) organic compounds comprising at least two free hydroxyl groups, which are capable of reacting with isocyanate groups,
ii) diols and polyols of the molecular weight range 62 to 299,
iii) synthesis components for the incorporation of terminal and/or lateral ethylene oxide units according to of formula (III)
H—Y′—X—Y—R (III)
wherein
R represents a monovalent hydrocarbon group with 1 to 12 carbon atoms,
X represents a polyalkylene oxide chain with 5 to 90 ethylene oxide units and optionally propylene oxide, butylene oxide or styrene oxide units, and
Y and Y¹ independently represent oxygen or —NR′—, wherein R′ represents H or C₁-C₁₈ alkyl or cycloalkyl,
iv) organic compounds having at least two free isocyanate groups per molecule, and
optionally
v) synthesis components which are at least monofunctional according to the isocyanate polyaddition reaction and additionally contain at least one anionic or one potentially anionic group selected from vA) mono and dihydroxy-carboxylic acids or their salts and vC) sulfonate group-containing aliphatic diols, and
vii) p-hydroxybenzoic acid esters of formula (II) 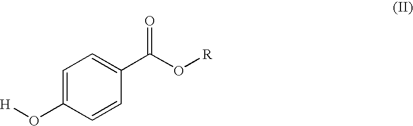
wherein R represents C₁ to C₁₈ alkyl or cyclo-alkyl,
to form a prepolymer, the required quantities of the individual synthesis components being measured in such as way as to result in an isocyanate index of 1.05 to 4.5, then
in a second stage, dissolving the prepolymer in an organic solvent and
optionally in a third stage reacting the isocyanate-containing prepolymer solution with
vB) mono- and/or diamino carboxylic acids or their salts and/or mono- and/or diamino sulfonic acids or their salts, and/or
vi) aliphatic and/or alicyclic primary and/or secondary polyamines
optionally neutralizing potentially anionic components before or after the third stage and either the components vA) or vC) being used in the first stage and/or component vB) being used in the third stage,
precipitating the dispersion in a fourth stage by the addition of water and
removing the organic solvent in a final stage.

6. A method of coating or producing substrates comprising applying the preparations according to claim 1 to a surface of the substrates.

7. A method of coating substrates comprising
optionally pre-coating the substrates with a coagulating agent,
optionally heating the substrate,
coating the substrate with or immersing the substrate in the aqueous preparation according to claim 1, and
heating the substrate to a temperature at which the p-hydroxybenzoic acid ester dissociates and the isocyanate groups thereby released react with the crosslinker forming a crosslinked polyurethane.

8. Polymers coated with preparations obtained according to claim 1 or substrates containing these.

9. The process according to claim 5, wherein the polyols in ii) comprise triols and/or the alkoxylation products of the diols, triols, and/or polyols.

10. The process according to claim 5, wherein R represents C₂ to C₈ alkyl or cyclo-alkyl.

11. The process according to claim 5, wherein the amino carboxylic acids are one or more selected from the group consisting of glycine, alanine, and diaminocarboxylic acids obtained by the addition of acrylic acid to primary aliphatic amines.

12. The process according to claim 5, wherein the amino sulfonic acids include taurine and/or the alkali salts of N-(2-aminoethyl)-2-aminoethane sulfonic acid.
